(19) United States
(12) Patent Application Publication
(10) Pub. No.: US 2022/0341527 A1
(43) Pub. Date: Oct. 27, 2022

(54) Mechanical Outlet

(71) Applicant: Victaulic Company, Easton, PA (US)

(72) Inventors: Matthew A. Bowman, Palmer, PA (US); Christopher A. Richards, Easton, PA (US); Christopher Albright, Allentown, PA (US)

(21) Appl. No.: 17/725,639

(22) Filed: Apr. 21, 2022

Related U.S. Application Data
(60) Provisional application No. 63/180,115, filed on Apr. 27, 2021.

(51) Int. Cl. F16L 41/12

(52) U.S. Cl. CPC F16L 41/12

(57) ABSTRACT

A mechanical outlet forms a Tee joint by using a strap to cinch a pipe element to a saddle having a duct. One end of the strap and saddle are attached via an adjustable fastener. Angularly oriented action and reaction surfaces on the saddle and strap engage one another when the fastener is tightened to place a tensile load on the strap which substantially conforms to the pipe element and compresses it against the saddle. The opposite ends of the strap and saddle engage one another via a yoke and enlarged head, allowing those ends to be disengaged to permit insertion of the pipe element between strap and saddle.

### CROSS REFERENCE TO RELATED APPLICATIONS

This application is based upon and claims priority to U.S. Provisional Application No. 63/180,115, filed Apr. 27, 2021, which application is hereby incorporated by reference.

### FIELD OF THE INVENTION

This invention concerns mechanical outlets for connecting pipe elements and other components.

### BACKGROUND

Saddle type mechanical outlets forming “Tee” joints are effective but suffer a disadvantage because installation often requires that four or more separate parts be handled by a technician. Installation is thus time consuming and may be difficult when the joint to be formed is in a location which is crowded with other pipes, fittings and equipment, or is awkwardly positioned close to a wall, floor or ceiling where access is limited. There is clearly an opportunity to improve mechanical outlets to form Tee joints more quickly.

### SUMMARY

The invention concerns a mechanical outlet for forming a Tee joint in a pipe element. In an example embodiment the mechanical outlet comprises a saddle partially surrounding a central space for receiving the pipe element. A duct extends through the saddle and has an inner portion extending into the central space. The inner portion is engageable with an opening in the pipe element. A strap partially surrounds the central space. A first end of the strap is attached to a first end of the saddle via an adjustable fastener. A second end of the strap and a second end of the saddle comprise a hook assembly for attachment of the strap to the saddle. The strap is pivotable at the first end between a first position wherein the second end of the strap is not attached to the second end of the saddle, and a second position wherein the second end of the strap is attached to the second end of the saddle.

By way of example, the duct may further comprise an outer portion projecting from the saddle. An action surface may be positioned proximate the first end of the saddle, and a reaction surface may be positioned proximate the first end of the strap in facing relation with the action surface. In an example embodiment, the action surface and the reaction surface are angularly oriented with respect to a longitudinal axis of the adjustable fastener such that the strap is pulled toward the first end of the saddle when the adjustable fastener is adjusted to draw the first ends of the saddle and the strap toward one another engaging the action and reaction surfaces.

In an example embodiment the action surface comprises an inboard action surface positioned between the central space and the adjustable fastener, and an outboard action surface. The adjustable fastener is positioned between the inboard action surface and the outboard action surface. The reaction surface comprises an inboard reaction surface which is positioned between the central space and the adjustable fastener, and an outboard reaction surface. The adjustable fastener is positioned between the inboard reaction surface and the outboard reaction surface.

In an example embodiment the hook assembly comprises a yoke positioned at the second end of either the saddle or the strap and an enlarged head positioned at the second end of either the saddle or the strap. The head engages the yoke for attaching the second end of the strap to the second end of the saddle. In a specific example the yoke is positioned on the second end of the saddle and the enlarged head is positioned on the second end of the strap.

An example embodiment may further comprise a saddle lug positioned on the first end of the saddle. The saddle lug defines an opening for receiving the adjustable fastener. A strap lug is positioned on the first end of the strap. The strap lug defines an opening for receiving the adjustable fastener. At least one of the saddle lug or the strap lug defines a clearance space adjacent to the adjustable fastener. By way of example the adjustable fastener may comprise a bolt and a nut. In a further example, the outer portion of the duct comprises a circumferential groove extending there around. A seal may surround the inner portion of the duct. The outer portion of the duct may be threaded.

An example mechanical outlet according to the invention may further comprise a relief region positioned proximate to the first end of the strap and facing the central space. In a specific example the relief region comprises a portion of the strap wherein a curvature of a surface of the strap is altered to provide clearance and thereby better accommodate the pipe element.

The invention further encompasses a factory preassembled mechanical outlet for forming a Tee joint in a pipe element. In an example embodiment, the factory preassembled mechanical outlet comprises a saddle partially surrounding a central space for receiving the pipe element. A duct extends through the saddle and has an inner portion extending into the central space and is engageable with an opening in the pipe element. A strap partially surrounds the central space. A first end of the strap is attached to a first end of the saddle via an adjustable fastener. A second end of the strap and a second end of the saddle comprise a hook assembly for attachment of the strap to the saddle. The factory preassembled mechanical outlet is provided in either a first or a second factory preassembled state. In the first factory preassembled state the strap is pivoted at the first end into a first position wherein the second end of the strap is not attached to the second end of the saddle. In the second factory preassembled state the strap is pivoted into a second position wherein the second end of the strap is attached to the second end of the saddle.

By way of example, the duct further comprises an outer portion projecting from the saddle. Also by way of example, the factory preassembled mechanical outlet according to the invention further comprises an action surface positioned proximate the first end of the saddle. A reaction surface is positioned proximate the first end of the strap in facing relation with the action surface. The action surface and the reaction surface are angularly oriented with respect to a longitudinal axis of the adjustable fastener such that the strap is pulled toward the first end of the saddle when the adjustable fastener is adjusted to draw the first ends of the saddle and the strap toward one another engaging the action and reaction surfaces.

In an example embodiment the action surface comprises an inboard action surface positioned between the central space and the adjustable fastener, and an outboard action surface. The adjustable fastener is positioned between the inboard action surface and the outboard action surface. The action surface also comprises a reaction surface comprising an inboard reaction surface positioned between the central space and the adjustable fastener and an outboard reaction surface. The adjustable fastener is positioned between the inboard reaction surface and the outboard reaction surface.

In an example embodiment according to the invention the hook assembly comprises a yoke positioned at the second end of either the saddle or the strap. An enlarged head is positioned at the second end of either the saddle or the strap. The head engages the yoke for attaching the second end of the strap to the second end of the saddle. By way of example the yoke is positioned on the second end of the saddle and the enlarged head is positioned on the second end of the strap.

An example embodiment of the factory preassembled mechanical outlet according to the invention may further comprise a saddle lug positioned on the first end of the saddle. The saddle lug defines an opening for receiving the adjustable fastener. A strap lug is positioned on the first end of the strap. The strap lug defines an opening for receiving the adjustable fastener. At least one of the saddle lug or the strap lug defines a clearance space adjacent to the adjustable fastener. By way of example the adjustable fastener comprises a bolt and a nut. In an example embodiment the outer portion of the duct comprises a circumferential groove extending there around. A seal may surround the inner portion of the duct. The outer portion of the duct may be threaded in an example. A relief region may be positioned proximate to the first end of the strap, facing the central space. In an example embodiment the relief region comprises a portion of the strap wherein a curvature of a surface of the strap is altered to provide clearance and thereby better accommodate the pipe element.

The invention further encompasses a method for forming a Tee joint in a pipe element using a factory preassembled mechanical outlet according to the invention. In an example embodiment the method comprises:
when the factory preassembled mechanical outlet is provided in either the first or the second factory preassembled state:
positioning the pipe element within the central space;
engaging the inner portion of the duct with the opening in the pipe element;
when the factory preassembled mechanical outlet is provided in the first factory preassembled state:
pivoting the strap about the first end thereof, thereby moving the second end of the strap toward the second end of the saddle;
attaching the second end of the strap to the second end of the saddle; and
when the factory preassembled mechanical outlet is provided in either the first or the second factory preassembled state:
adjusting the adjustable fastener to draw the first ends of the saddle and the strap toward one another, thereby pulling the strap toward the first end of the saddle.

### BRIEF DESCRIPTION OF THE DRAWINGS

FIGS. 1 and 2 are isometric views of an example mechanical outlet according to the invention shown in a first factory preassembled state;

FIG. 3 is a cross sectional view of an example mechanical outlet according to the invention;

FIG. 3A is a cross sectional view of a portion of the mechanical outlet shown in FIG. 3 on an enlarged scale;

FIG. 3B is a cross sectional view of a portion of the mechanical outlet shown in FIG. 3 on an enlarged scale;

FIG. 3c is a cross sectional view of the example mechanical outlet shown in FIG. 3 assembled with a pipe element;

FIG. 3d is an axial view of the example mechanical outlet shown in FIG. 3 being assembled on a pipe element; and

FIGS. 4 and 5 are isometric views of an example mechanical outlet shown in a second factory preassembled state.

### DETAILED DESCRIPTION

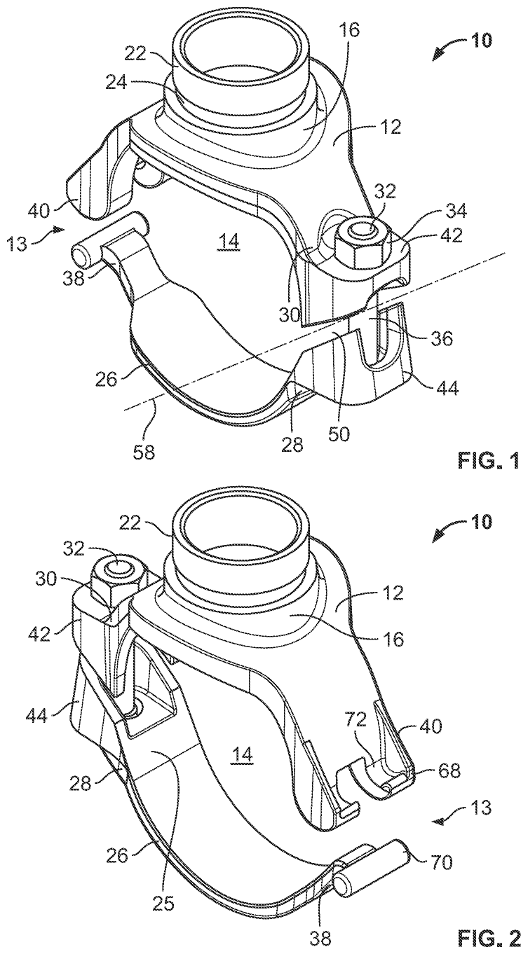

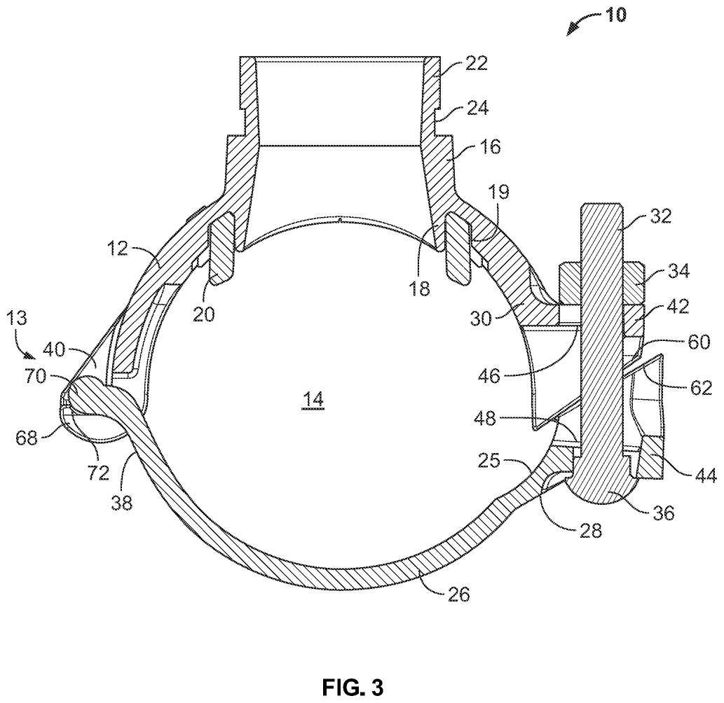

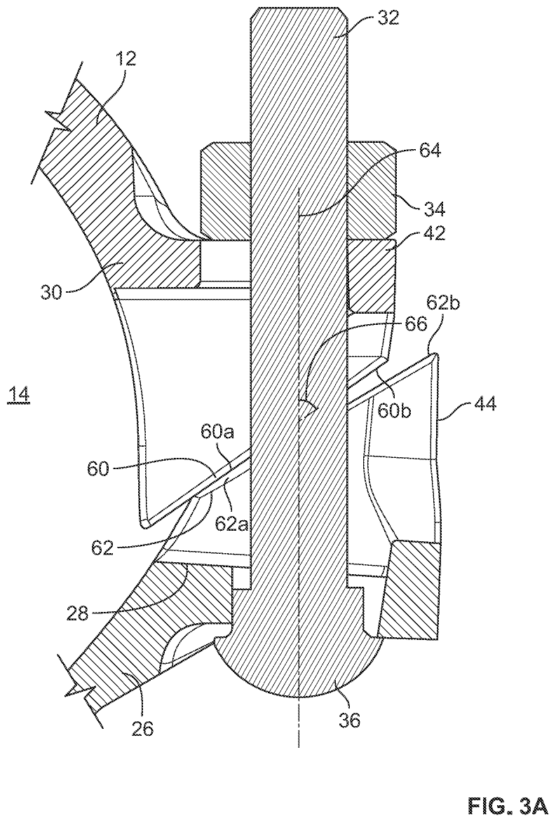

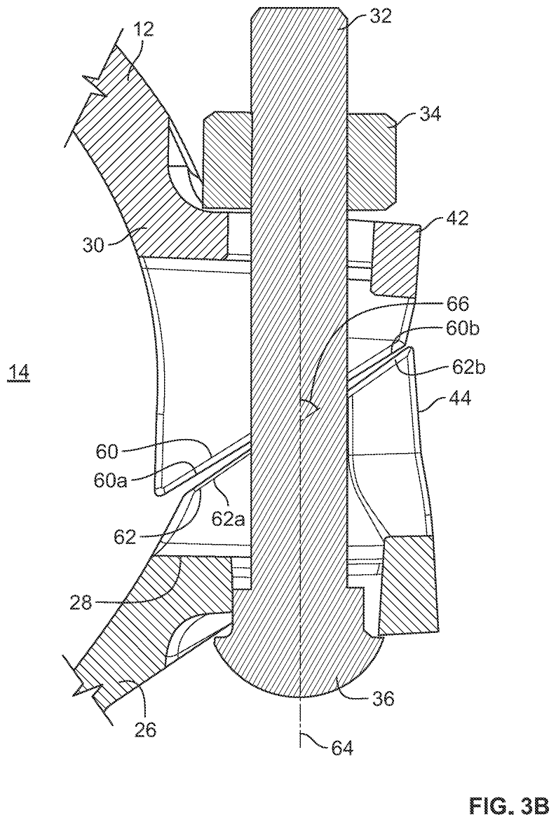

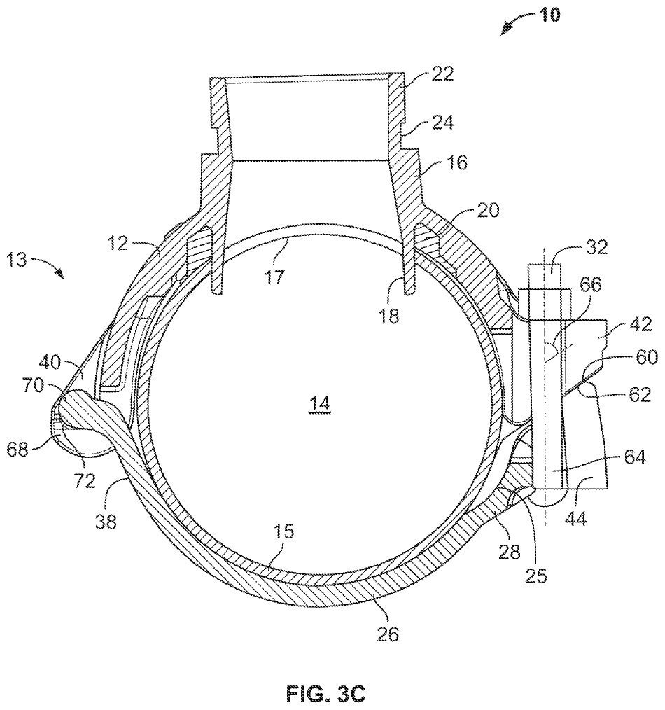

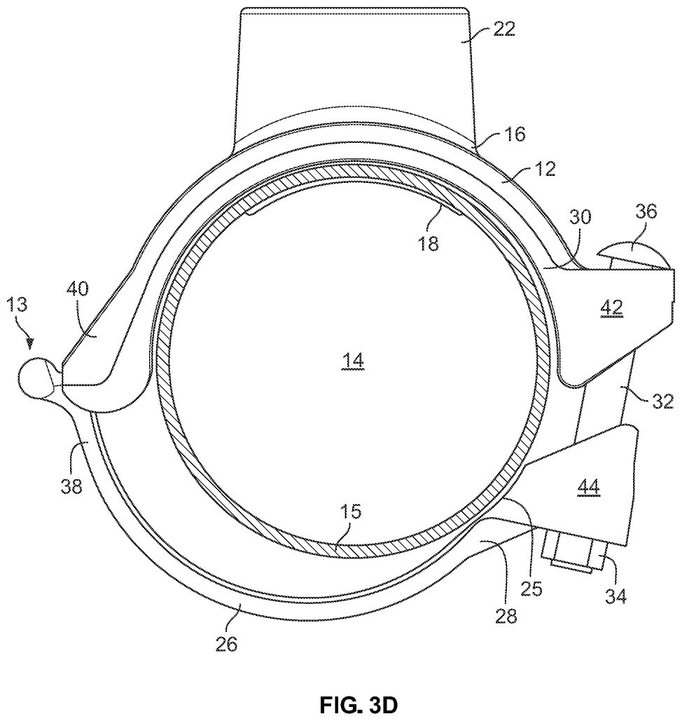

The invention concerns a mechanical outlet for forming a Tee joint in a pipe element. FIGS. 1 and 2 show an example mechanical outlet 10 according to the invention. Mechanical outlet 10 comprises a saddle 12 which partially surrounds a central space 14 for receiving the pipe element (not shown). Saddle 12 is provided in different sizes having different radii of curvature to accommodate different pipe diameters. A duct 16 extends through the saddle 12. As shown in FIG. 3, duct 16 has an inner portion 18 extending into the central space 14. Inner portion 18 is sized to engage an opening in the sidewall of the pipe element. A seal 20 surrounds the inner portion 18 of duct 16 and provides a seal between the saddle 12 and the pipe element when compressed therebetween. An example seal 20 is formed of an elastomer such as a rubber compound and may comprise a simple gasket or a pressure activated seal to cite some example seal structures. In a factory preassembled mechanical outlet (described below) it is advantageous if seal 20 is retained to the saddle 12 so as not to be a loose part during assembly of a joint. Seal 20 may be retained via a friction fit against the inner portion 18, or against the saddle, within a pocket 19. As further shown in FIGS. 1-3, the duct 16 may also comprise an outer portion 22 which projects from the saddle 12 away from the central space 14. Outer portion 22 is engageable with another component, such as a valve, a sprinkler or another pipe element to cite some examples. In this example embodiment the outer portion 22 of duct 16 is provided with a circumferential groove 24 to permit attachment via a mechanical coupling. Outer portion 22 may also be threaded, with internal or external threads as appropriate for compatibility with a particular component.

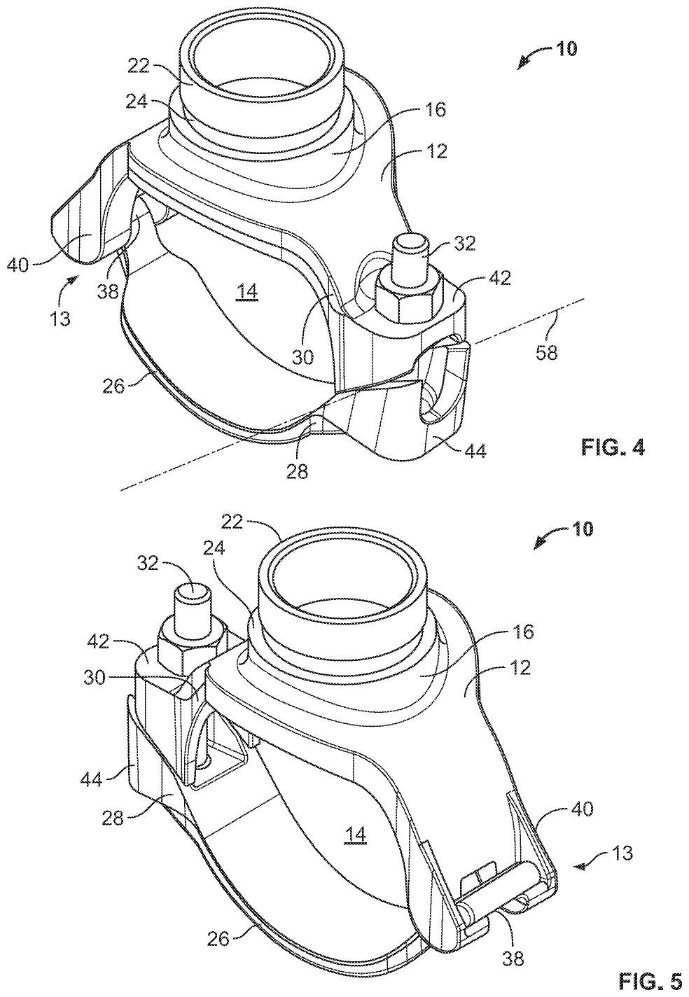

Mechanical outlet 10 also comprises a strap 26. Strap 26 may be formed from the same material as the saddle 12 (ductile iron for example) and also partially surrounds the central space 14. As shown in FIG. 3, a first end 28 of the strap 26 is attached to a first end 30 of the saddle 12. In this example, attachment is via an adjustable fastener 32 (henceforth, “fastener 32”) comprising a nut 34 and bolt 36. As shown by a comparison of FIGS. 1 and 2 with FIGS. 4 and 5, a second end 38 of the strap 26 is attachable to a second end 40 of the saddle 12 via a hook assembly 13 (described below). FIGS. 1 and 2 show mechanical outlet 10 in a configuration wherein the second end 38 of the strap 26 is not attached to the second end 40 of the saddle 12. This first position of the strap 26 represents a first factory preassembled state of the mechanical outlet 10 as explained below. FIGS. 4 and 5 show the strap 26 in a second position comprising a second factory preassembled state wherein the second end 38 of the strap is attached to the second end 40 of the saddle 12. Strap 26 is pivotable at the first end 28 between the first and second positions.

Pivotable attachment between the saddle 12 and the strap 26 is effected in this example embodiment using a saddle lug 42 positioned on the first end 30 of the saddle 12, and a strap lug 44 positioned on the first end 28 of the strap 26. Both the saddle lug 42 and the strap lug 44 define respective openings 46 and 48 for receiving the fastener 32 (see FIG. 3). As shown in the first factory preassembled state in FIG. 1, the fastener 32 is adjusted so that it retains the strap 26 to the saddle 12 while allowing a gap 50 between the lugs 42 and 44 which permits the strap and saddle to pivot relative to one another. This pivoting capability permits the mechanical outlet 10 to be opened to receive a pipe element in the central space 14 during assembly. As the pivoting motion occurs about the fastener 32, it is advantageous that at least one or both of the respective openings 46 and 48 of the saddle lug 42 and the strap lug 44 are shaped and sized to define clearance space in the lug or lugs about the fastener 32 so as to permit pivoting motion between the saddle 12 and strap 26.

FIGS. 3, 3A, 3B and 3C illustrate a cinching feature of the mechanical outlet 10. The cinching feature is effected by engagement between an action surface 60 and a reaction surface 62 (FIG. 3A). Action surface 60 is positioned on saddle 12 proximate its first end 30 and the reaction surface 62 is positioned on strap 26 proximate its first end 28. In this example the action and reaction surfaces are on the saddle lug 42 and the strap lug 44 respectively. Action surface 60 is in facing relation with the reaction surface 62. As shown in FIGS. 3A and 3B, action surface 60 on saddle 12 may be divided into an “inboard” action surface 60a and an “outboard” action surface 60b, the inboard action surface 60a being positioned between the central space 14 and the fastener 32, and the fastener 32 being between the outboard action surface 60b and the inboard action surface 60a. Similarly, reaction surface 62 may be divided into an “inboard” reaction surface 62a and an “outboard” reaction surface 62b. The inboard reaction surface 62a is positioned between the central space 14 and the fastener 32; the fastener 32 is positioned between the outboard reaction surface 62b and the inboard reaction surface 62a.

Outlet 10 is designed to accommodate a range of pipe element outer diameter tolerances as illustrated in FIGS. 3A and 3B. FIG. 3A shows the inboard action surface 60a engaging the inboard reaction surface 62a, there being a gap between the outboard action surface 60b and the outboard reaction surface 62b. This situation occurs when a pipe element having an outer diameter at the lower end of the outer diameter tolerance range is received within the central space 14 prior to the fastener 32 being tightened. FIG. 3B shows the outboard action surface 60b engaging the outboard reaction surface 62b, there being a gap between the inboard action surface 60a and the inboard reaction surface 62a. This situation occurs when a pipe element having an outer diameter at the upper end of the outer diameter tolerance range is received within the central space 14 prior to the fastener 32 being tightened.

The action surface 60 and the reaction surface 62 are initially angularly oriented with respect to a longitudinal axis 64 of fastener 32 such that when the fastener is adjusted (tightened) to draw them into engagement, the compressive force applied by fastener 32, working through the angularly oriented interface between the action and reaction surfaces 60 and 62, causes the strap 26 to be pulled toward the first end 30 of the saddle 12. Tension is thus developed in the strap 26 when, as shown in FIG. 3, its second end 38 is attached to the second end 40 of saddle 12. As shown in FIG. 3C, tension force applied to strap 26 will bring the action and reaction surfaces 60 and 62 into facing engagement and compress a pipe element 15 received within the central space 14 against the saddle 12, thereby also compressing the seal 20 to effect a fluid tight joint between the mechanical outlet and the pipe element. For practical designs the orientation angle 66 between the action and reaction surfaces 60, 62 and the longitudinal axis 64 of fastener 32 may range from 30° to 60°, with an orientation angle of about 55° being advantageous. It is further advantageous if the radius of curvature of the strap 26, when undeformed (FIG. 3), is greater than the radius of the outer surface of the pipe element which it engages. This dimensional relation allows for easier insertion of the pipe element into the central space 14 and also permits the strap 26 to substantially conform to the pipe element for enhanced cinching action (FIG. 3C). The saddle 12, when undeformed (FIG. 3), advantageously has a radius of curvature substantially matched to the outer surface of the pipe element within a tolerance range.

As further shown in FIG. 3B, pivoting motion between the saddle 12 and strap 26 may be limited using outboard action and reaction surfaces 60b and 62b as a stop surface. The facing relation of the action and reaction surfaces 60b and 62b as well as their proximity (controlled by the fastener 32) is such that the outboard reaction surface 62b may contact the outboard action surface 60b when the second end 38 of the strap 26 is not attached to the second end 40 of the saddle 12, and thereby limit the extent of pivoting motion between the strap and saddle about an axis 58 (see FIG. 1) passing between the lugs 42 and 44 that is substantially parallel to the longitudinal axis of a pipe element (not shown) received within the central space 14.

As shown in FIGS. 2 and 3, the second ends 38 and 40 of strap 26 and saddle 12 are releaseably attachable to one another using the hook assembly 13. In this example embodiment, hook assembly 13 comprises a yoke 68 which receives an enlarged head 70. In this example embodiment yoke 68 is positioned at the second end 40 of saddle 12 and the enlarged head 70 is positioned at the second end 38 of strap 26, although the positions could be reversed. To provide positive mechanical engagement between yoke 68 and enlarged head 70 the enlarged head may be cylindrically shaped to be received within concave surfaces 72 formed in the yoke 68.

Use of mechanical outlet 10 to form a Tee joint begins with the mechanical outlet being received in one of the two factory preassembled states as shown in FIGS. 1 and 2 (the first factory preassembled state) or 4 and 5 (the second factory preassembled state). Mechanical outlet 10 may be provided as shown, or a component, such as a valve or a sprinkler may be supplied attached to the outer portion 22 of duct 16. The first ends 28 and 30 of the strap 26 and the saddle 12 are loosely attached to one another by the fastener 32. The second ends 38 and 40 of the strap 26 and saddle 12 may or may not be engaged. A pipe element (not shown) may be positioned within the central space 14 surrounded by the saddle and strap in either the first or second factory preassembled states. When mechanical outlet 10 is in the second factory preassembled state (FIGS. 4 and 5) the pipe element may be positioned in the central space 14 by inserting a free end of the pipe element into the central space 14. When mechanical coupling 10 is in the first factory preassembled state (FIGS. 1 and 2), the pipe element is positioned within the central space 14 by passing the pipe element intermediate its ends between the respective disengaged ends 38 and 40 of strap 26 and the saddle 12. As shown in FIG. 3C, the inner portion 18 of the duct 16 would next be engaged with an opening 17 in the pipe element 15, with the seal 20 being initially compressed between the pipe element and the saddle 12. As shown in FIGS. 1-3 and 3C, if in the first factory preassembled state, the strap 26 is pivoted about axis 58 at its first end, thereby moving the second end 38 of the strap toward the second end 40 of the saddle. The second end 38 of the strap 26 is then attached to the second end 40 of the saddle 12 by engaging the enlarged head 70 with the concave surfaces 72 of the yoke 68. Next the fastener 32 is tightened to draw the first ends 28 and 30 of the strap 26 and the saddle 12 toward one another to engage the action surface 60 with the reaction surface 62 (see FIG. 3B). Further tightening of the fastener 32 causes the action and reaction surfaces to slide across one another, thereby pulling the strap 26 toward the first end 30 of the saddle 12. Tension on the strap 26 causes it to deform and cinch the pipe element against the saddle, compressing the seal 20 to form a fluid tight joint between the pipe element and the mechanical outlet 10. A component, such as a second pipe element, a valve, a sprinkler or the like (not shown) may then be attached to the outer portion 22 of the duct 16 if not already present. Attachment may be effected for example, using a mechanical coupling to engage the groove 24, or the outer portion 22 may be threaded (inner or outer threads) as necessary to accommodate the particular component of interest. As shown in FIGS. 2, 3 and 3D, it is advantageous to include a relief region 25 on the strap 26, the relief region being located proximate to the first end 28 of strap 26 and facing the central space 14. Relief region 25 comprises a portion of the strap 26 wherein the curvature of a surface of the strap is altered to provide clearance and better accommodate the pipe element 15 during assembly of the mechanical outlet 10. Relief region 25 is beneficial for assembly of both the first and second factory preassembled states and may be formed, for example, during casting of the strap 26, or the strap may be machined to include the relief region 25.

Mechanical outlets according to the invention are expected to provide numerous advantages, including more efficient assembly of a connection because no loose parts need to be handled and only one bolt needs to be tightened to secure the joint. The pad to pad engagement provides a visual indication that the assembly is complete, and obviates the need to measure the torque applied to the fastener. Pad to pad engagement also avoids the failure mode wherein the lugs shear off of the strap or saddle due to an over-torqued fastener.

All of the embodiments of the claimed invention described herein are provided expressly by way of example only. Innumerable variations and modifications may be made to the example embodiments described herein without departing from the concept of this disclosure. Additionally, the scope of this disclosure is intended to encompass any and all modifications and combinations of all elements, features, and aspects described in the specification and claims, and shown in the drawings. Any and all such modifications and combinations are intended to be within the scope of this disclosure.

What is claimed is:

1. A mechanical outlet for forming a Tee joint in a pipe element, said mechanical outlet comprising:
a saddle partially surrounding a central space for receiving said pipe element, a duct extending through said saddle and having an inner portion extending into said central space and engageable with an opening in said pipe element;
a strap partially surrounding said central space, a first end of said strap being attached to a first end of said saddle via an adjustable fastener, a second end of said strap and a second end of said saddle comprising a hook assembly for attachment of said strap to said saddle; wherein
said strap is pivotable at said first end between a first position wherein said second end of said strap is not attached to said second end of said saddle, and a second position wherein said second end of said strap is attached to said second end of said saddle.

2. The mechanical outlet according to claim 1, wherein said duct further comprises an outer portion projecting from said saddle.

3. The mechanical outlet according to claim 1, further comprising:
an action surface positioned proximate said first end of said saddle;
a reaction surface positioned proximate said first end of said strap in facing relation with said action surface; wherein
said action surface and said reaction surface are angularly oriented with respect to a longitudinal axis of said adjustable fastener such that said strap is pulled toward said first end of said saddle when said adjustable fastener is adjusted to draw said first ends of said saddle and said strap toward one another engaging said action and reaction surfaces.

4. The mechanical outlet according to claim 3, wherein said action surface comprises:
an inboard action surface positioned between said central space and said adjustable fastener;
an outboard action surface, said adjustable fastener positioned between said inboard action surface and said outboard action surface; and wherein
said reaction surface comprises:
an inboard reaction surface positioned between said central space and said adjustable fastener; and
an outboard reaction surface, said adjustable fastener being positioned between said inboard reaction surface and said outboard reaction surface.

5. The mechanical outlet according to claim 1, wherein said hook assembly comprises:
a yoke positioned at said second end of either said saddle or said strap;
an enlarged head positioned at said second end of either said saddle or said strap, said head engaging said yoke for attaching said second end of said strap to said second end of said saddle.

6. The mechanical outlet according to claim 5, wherein said yoke is positioned on said second end of said saddle and said enlarged head is positioned on said second end of said strap.

7. The mechanical outlet according to claim 1, further comprising:
a saddle lug positioned on said first end of said saddle, said saddle lug defining an opening for receiving said adjustable fastener;
a strap lug positioned on said first end of said strap, said strap lug defining an opening for receiving said adjustable fastener.

8. The mechanical outlet according to claim 7, wherein at least one of said saddle lug or said strap lug defines a clearance space adjacent to said adjustable fastener.

9. The mechanical outlet according to claim 1, wherein said adjustable fastener comprises a bolt and a nut.

10. The mechanical outlet according to claim 2, wherein said outer portion of said duct comprises a circumferential groove extending there around.

11. The mechanical outlet according to claim 1, further comprising a seal surrounding said inner portion of said duct.

12. The mechanical outlet according to claim 2, wherein said outer portion of said duct is threaded.

13. The mechanical outlet according to claim 1, further comprising a relief region positioned proximate to said first end of said strap and facing said central space.

14. The mechanical outlet according to claim 13, wherein said relief region comprises a portion of said strap wherein a curvature of a surface of said strap is altered to provide clearance and thereby better accommodate said pipe element.

15. A factory preassembled mechanical outlet for forming a Tee joint in a pipe element, said factory preassembled mechanical outlet comprising:
a saddle partially surrounding a central space for receiving said pipe element, a duct extending through said saddle and having an inner portion extending into said central space and engageable with an opening in said pipe element;
a strap partially surrounding said central space, a first end of said strap being attached to a first end of said saddle via an adjustable fastener, a second end of said strap and a second end of said saddle comprising a hook assembly for attachment of said strap to said saddle; wherein
said factory preassembled mechanical outlet is provided in either a first or a second factory preassembled state, wherein:
in said first factory preassembled state said strap is pivoted at said first end into a first position wherein said second end of said strap is not attached to said second end of said saddle; and
wherein in said second factory preassembled state said strap is pivoted into a second position wherein said second end of said strap is attached to said second end of said saddle.

16. The factory preassembled mechanical outlet according to claim 15, wherein said duct further comprises an outer portion projecting from said saddle.

17. The factory preassembled mechanical outlet according to claim 15, further comprising:
an action surface positioned proximate said first end of said saddle;
a reaction surface positioned proximate said first end of said strap in facing relation with said action surface; wherein
said action surface and said reaction surface are angularly oriented with respect to a longitudinal axis of said adjustable fastener such that said strap is pulled toward said first end of said saddle when said adjustable fastener is adjusted to draw said first ends of said saddle and said strap toward one another engaging said action and reaction surfaces.

18. The factory preassembled mechanical outlet according to claim 17, wherein said action surface comprises:
an inboard action surface positioned between said central space and said adjustable fastener;
an outboard action surface, said adjustable fastener being positioned between said inboard action surface and said outboard action surface; and wherein
said reaction surface comprises:
an inboard reaction surface positioned between said central space and said adjustable fastener; and
an outboard reaction surface, said adjustable fastener being positioned between said inboard reaction surface and said outboard reaction surface.

19. The factory preassembled mechanical outlet according to claim 15, wherein said hook assembly comprises:
a yoke positioned at said second end of either said saddle or said strap;
an enlarged head positioned at said second end of either said saddle or said strap, said head engaging said yoke for attaching said second end of said strap to said second end of said saddle.

20. The factory preassembled mechanical outlet according to claim 19, wherein said yoke is positioned on said second end of said saddle and said enlarged head is positioned on said second end of said strap.

21. The factory preassembled mechanical outlet according to claim 15, further comprising:
a saddle lug positioned on said first end of said saddle, said saddle lug defining an opening for receiving said adjustable fastener;
a strap lug positioned on said first end of said strap, said strap lug defining an opening for receiving said adjustable fastener.

22. The factory preassembled mechanical outlet according to claim 21, wherein at least one of said saddle lug or said strap lug defines a clearance space adjacent to said adjustable fastener.

23. The factory preassembled mechanical outlet according to claim 15, wherein said adjustable fastener comprises a bolt and a nut.

24. The factory preassembled mechanical outlet according to claim 16, wherein said outer portion of said duct comprises a circumferential groove extending there around.

25. The factory preassembled mechanical outlet according to claim 15, further comprising a seal surrounding said inner portion of said duct.

26. The factory preassembled mechanical outlet according to claim 16, wherein said outer portion of said duct is threaded.

27. The factory preassembled mechanical outlet according to claim 15, further comprising a relief region positioned proximate to said first end of said strap and facing said central space.

28. The factory preassembled mechanical outlet according to claim 27, wherein said relief region comprises a portion of said strap wherein a curvature of a surface of said strap is altered to provide clearance and thereby better accommodate said pipe element.

29. A method for forming a Tee joint in a pipe element using said factory preassembled mechanical outlet according to claim 15, said method comprising:
when said factory preassembled mechanical outlet is provided in either said first or said second factory preassembled state:
positioning said pipe element within said central space;
engaging said inner portion of said duct with said opening in said pipe element;
when said factory preassembled mechanical outlet is provided in said first factory preassembled state:
pivoting said strap about said first end thereof, thereby moving said second end of said strap toward said second end of said saddle;
attaching said second end of said strap to said second end of said saddle; and
when said factory preassembled mechanical outlet is provided in either said first or said second factory preassembled state:
adjusting said adjustable fastener to draw said first ends of said saddle and said strap toward one another, thereby pulling said strap toward said first end of said saddle.
